(19) United States
(12) Patent Application Publication
(10) Pub. No.: US 2023/0036683 A1
(43) Pub. Date: Feb. 2, 2023

(54) Multi-Beam Channel State Information (CSI) Evaluation

(71) Applicant: Apple Inc., Cupertino, CA (US)

(72) Inventors: Sai Sravan Bharadwaj Karri, Morgan Hill, CA (US); Guillaume Monghal, Cupertino, CA (US); Maik Streller, Munich (DE); Manish G. Vemulapalli, Campbell, CA (US); Sagar B. Shah, San Jose, CA (US); Karthik Chockalingam, Cupertino, CA (US)

(21) Appl. No.: 17/384,262

(22) Filed: Jul. 23, 2021

(51) Int. Cl. H04B 7/08; H04B 7/0408; H04B 7/06; H04L 5/00

(52) U.S. Cl. CPC H04B 7/0888; H04B 7/0408; H04B 7/0626; H04L 5/0051; H04B 7/0617

(57) ABSTRACT

A technique for wireless communications, comprising: determining a first channel state information (CSI) based on a current receive beam; determining a second CSI based on the current receive beam; determining a correlation metric between the first CSI and the second CSI; based a comparison between the determined correlation metric and a threshold value, determining to transmit the first or second CSI in response to a CSI reference signal (CSI-RS) received from a wireless node; determining a third CSI based on a candidate receive beam and the reference signal; and selecting the candidate receive beam based on the measured third CSI.

### FIELD

The present application relates to wireless devices, and more particularly to apparatus, systems, and methods for evaluating and selecting among beams using CSI measurements.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), BLUETOOTH, etc.

The ever increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including fifth generation (5G) new radio (NR) communication. Accordingly, improvements in the field in support of such development and design are desired.

### SUMMARY

Embodiments relate to apparatuses, systems, and methods for wireless communications, comprising: determining a first channel state information (CSI) based on a current receive beam; determining a second CSI based on the current receive beam; determining a correlation metric between the first CSI and the second CSI; based on a comparison between the determined correlation metric and a threshold value, determining to transmit one of the first CSI or the second CSI in response to a CSI reference signal (CSI-RS) received from a wireless node; determining a third CSI based on a candidate receive beam and the reference signal; and selecting the candidate receive beam based on the measured third CSI.

According to aspects of the present disclosure, a technique for wireless communications comprising: receiving, by a wireless device, a first transmit beam including a synchronization signal block (SSB); measuring a transmission power imbalance of the received SSB of the first transmit beam to determine a candidate transmit beam; tuning, by the wireless device, a receive beam based on the determined candidate transmit beam; receiving the candidate transmit beam using the receive beam; determining channel state information (CSI) for the candidate transmit beam; and selecting a second transmit beam for receiving based on the measured CSI.

According to aspects of the present disclosure, a technique for wireless communications comprising: receiving, by a wireless device, on a first transmit beam associated with on one antenna port, a channel state information reference signal (CSI-RS); tuning, by the wireless device, a receive beam based on a second transmit beam; receiving, by the wireless device, a demodulation reference signal (DMRS) and a tracking reference signal (TRS) transmitted on the second transmit beam; determining a rank estimate for the second transmit beam based on the DMRS and TRS; and selecting the second transmit beam for use based on the determined rank estimate.

According to aspects of the present disclosure, a wireless device comprising: a radio; and a processor operably coupled to the radio, wherein the processor is configured to: determine a first channel state information (CSI) based on a current receive beam; determine a second CSI based on the current receive beam; determine a correlation metric between the first CSI and the second CSI; based on a comparison between the determined correlation metric and a threshold value, determine to transmit one of the first CSI or the second CSI in response to a CSI reference signal (CSI-RS) transmitted from a wireless node; determine a third CSI based on a candidate receive beam and the reference signal; and select the candidate receive beam based on the measured third CSI.

According to aspects of the present disclosure, a wireless device comprising a radio; and a processor operably coupled to the radio, wherein the processor is configured to: receive a first transmit beam including a synchronization signal block (SSB); measure a transmission power imbalance of the received SSB of the first transmit beam to determine a candidate transmit beam; tune a receive beam based on the candidate transmit beam; receive the candidate transmit beam using the receive beam; determine channel state information (CSI) for the candidate transmit beam; and select the second transmit beam for use based on the measured CSI.

According to aspects of the present disclosure, a wireless device comprising: a radio; and a processor operably coupled to the radio, wherein the processor is configured to: receive on a first transmit beam transmitted on one antenna port, a channel state information reference signal (CSI-RS); tune a receive beam based on a second transmit beam; receive a demodulation reference signal (DMRS) and a tracking reference signal (TRS) transmitted on the second transmit beam; determine a rank estimate for the second transmit beam based on the DMRS and TRS; and select the second transmit beam for use based on the determined rank estimate.

According to aspects of the present disclosure, a non-volatile computer-readable medium storing instructions that, when executed, cause a processor to: determine a first channel state information (CSI) based on a current receive beam; determine a second CSI based on the current receive beam; determine a correlation metric between the first CSI and the second CSI; based on a comparison between the determined correlation metric and a threshold value, determine to transmit the first or second CSI in response to a CSI reference signal (CSI-RS) transmitted from a wireless node; determine a third CSI based on a candidate receive beam and the reference signal; and select the candidate receive beam based on the measured third CSI.

According to aspects of the present disclosure, a non-volatile computer-readable medium storing instructions that, when executed, cause a processor to: receive a first transmit beam including a synchronization signal block (SSB); measure a transmission power imbalance of the received SSB of the first transmit beam to determine a candidate transmit beam; tune a receive beam based on the candidate transmit beam; receive the candidate transmit beam using the receive beam; determine channel state information (CSI) for the candidate transmit beam; and select the second transmit beam for use based on the measured CSI.

According to aspects of the present disclosure, a non-volatile computer-readable medium storing instructions that, when executed, cause a processor to: receive on a first transmit beam transmitted on one antenna port, a channel state information reference signal (CSI-RS); tune a receive beam based on a second transmit beam; receive a demodulation reference signal (DMRS) and a tracking reference signal (TRS) transmitted on the second transmit beam; determine a rank estimate for the second transmit beam based on the DMRS and TRS; and select the second transmit beam for use based on the determined rank estimate.

The techniques described herein may be implemented in and/or used with a number of different types of devices, including but not limited to smartphones, cellular phones, tablet computers, portable computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter can be obtained when the following detailed description of various embodiments is considered in conjunction with the following drawings, in which:

FIG. 1 illustrates an example wireless communication system, according to some embodiments;

FIG. 2 illustrates an example base station (BS) in communication with a user equipment (UE) device, according to some embodiments;

FIG. 3 illustrates an example block diagram of a communication device, according to some embodiments;

FIG. 4 illustrates an example block diagram of a BS, according to some embodiments;

FIG. 5 illustrates an example block diagram of cellular communication circuitry, according to some embodiments;

FIG. 6 illustrates an example block diagram of a network element, according to some embodiments;

FIGS. 7A and 7B are diagrams illustrating an example beam management procedure, according to some embodiments.

FIG. 8 is a diagram illustrating example slot structures of a radio frame, according to some embodiments.

FIG. 9 is a flow diagram illustrating an example technique for selecting a receive beam, according to some embodiments.

FIG. 10 is a flow diagram illustrating an example technique for selecting a transmit beam, according to some embodiments.

FIG. 11 is a flow diagram illustrating an example technique for selecting a transmit beam, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

In certain wireless communications systems, a wireless device may be configured to provide feedback for every reception occasion. In some cases, feedback for each reception occasion is not needed and it may be beneficial to skip providing feedback for some reception occasions. In some cases, the feedback may be multiplexed with other transmissions. Skipping providing feedback may change how the multiplexing may be performed. Techniques for how to provide potentially skipped feedback multiplexed with other transmissions may be provided.

The following is a glossary of terms that may be used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (also “User Device” or “UE Device”)—any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, etc. In general, the term “UE” or “UE device” can be broadly defined to encompass any electronic, computing, and/or telecommunications device (or combination of devices) which is transportable by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “base station” or “wireless station” has the full breadth of its ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or eNB′ If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” etc., may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” etc., are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some aspects, “approximately” may mean within 0.1% of some specified or desired value, while in various other aspects, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

Example Wireless Communication System

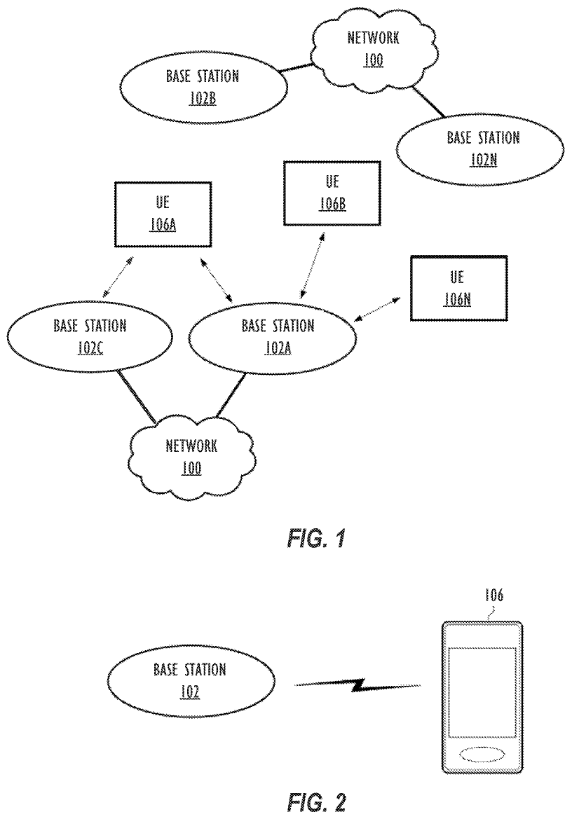

Turning now to FIG. 1, a simplified example of a wireless communication system is illustrated, according to some embodiments. It is noted that the system of FIG. 1 is merely one example of a possible system, and that features of this disclosure may be implemented in any of various systems, as desired.

As shown, the example wireless communication system includes a base station 102A, which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”), and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB.” In some embodiments, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

Example User Equipment (UE)

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer, a laptop, a tablet, a smart watch or other wearable device, or virtually any type of wireless device.

The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, NR or LTE using at least some shared radio components. As additional possibilities, the UE 106 could be configured to communicate using CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

Example Communication Device

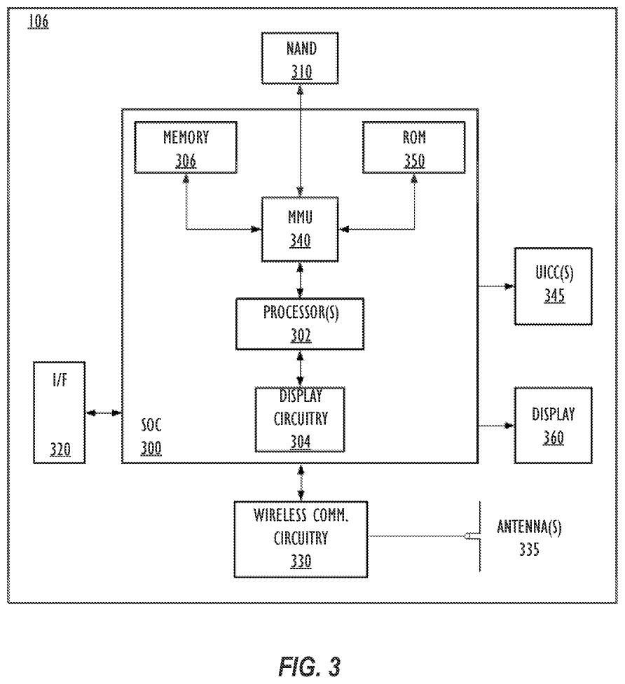

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, etc.). In some embodiments, communication device 106 may include wired communication circuitry (not shown), such as a network interface card, e.g., for Ethernet.

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry, and may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include one or more receive chains (including and/or coupled to (e.g., communicatively; directly or indirectly) dedicated processors and/or radios) for multiple RATs (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with a second radio. The second radio may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, etc.) configured to perform the functions of wireless communication circuitry 330.

Example Base Station

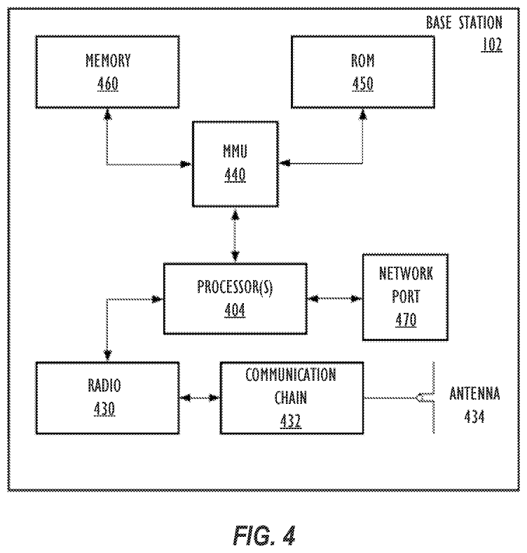

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB.” In such embodiments, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

Example Cellular Communication Circuitry

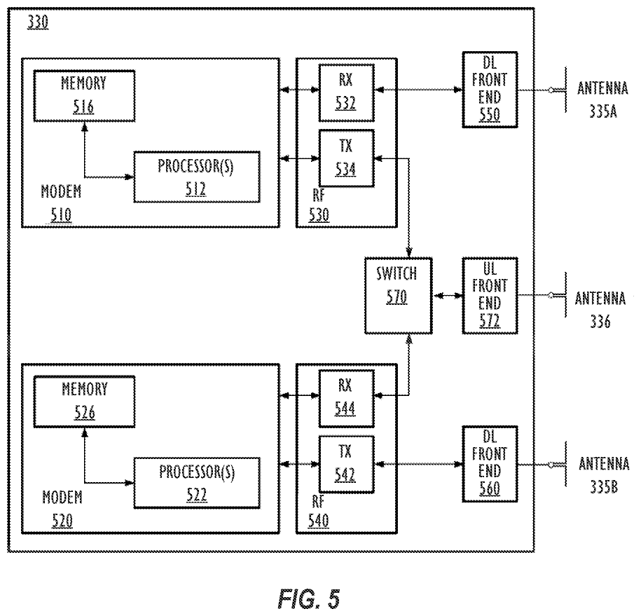

FIG. 5 illustrates an example simplified block diagram of cellular communication circuitry, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that may be shared among multiple RATs, are also possible. According to some embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown. In some embodiments, cellular communication circuitry 330 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 330 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more processing elements. Thus, processors 512, 522 may include one or more integrated circuits (ICs) that are configured to perform the functions of processors 512, 522. In addition, each integrated circuit may include circuitry (e.g., first circuitry, second circuitry, etc.) configured to perform the functions of processors 512, 522.

In some embodiments, the cellular communication circuitry 330 may include only one transmit/receive chain. For example, the cellular communication circuitry 330 may not include the modem 520, the RF front end 540, the DL front end 560, and/or the antenna 335b. As another example, the cellular communication circuitry 330 may not include the modem 510, the RF front end 530, the DL front end 550, and/or the antenna 335a. In some embodiments, the cellular communication circuitry 330 may also not include the switch 570, and the RF front end 530 or the RF front end 540 may be in communication, e.g., directly, with the UL front end 572.

Example Network Element

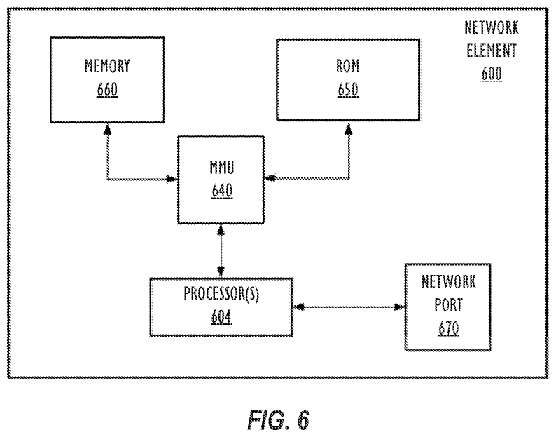

FIG. 6 illustrates an exemplary block diagram of a network element 600, according to some embodiments. According to some embodiments, the network element 600 may implement one or more logical functions/entities of a cellular core network, such as a mobility management entity (MME), serving gateway (S-GW), access and management function (AMF), session management function (SMF), network slice quota management (NSQM) function, etc. It is noted that the network element 600 of FIG. 6 is merely one example of a possible network element 600. As shown, the core network element 600 may include processor(s) 604 which may execute program instructions for the core network element 600. The processor(s) 604 may also be coupled to memory management unit (MMU) 640, which may be configured to receive addresses from the processor(s) 604 and translate those addresses to locations in memory (e.g., memory 660 and read only memory (ROM) 650) or to other circuits or devices.

The network element 600 may include at least one network port 670. The network port 670 may be configured to couple to one or more base stations and/or other cellular network entities and/or devices. The network element 600 may communicate with base stations (e.g., eNBs/gNBs) and/or other network entities/devices by means of any of various communication protocols and/or interfaces.

As described further subsequently herein, the network element 600 may include hardware and software components for implementing and/or supporting implementation of features described herein. The processor(s) 604 of the core network element 600 may be configured to implement or support implementation of part or all of the methods described herein, e.g., by executing program instructions stored on a memory medium (e.g., a nontransitory computer-readable memory medium). Alternatively, the processor 604 may be configured as a programmable hardware element, such as an FPGA (Field Programmable Gate Array), or as an ASIC (Application Specific Integrated Circuit), or a combination thereof.

Example Beam Management

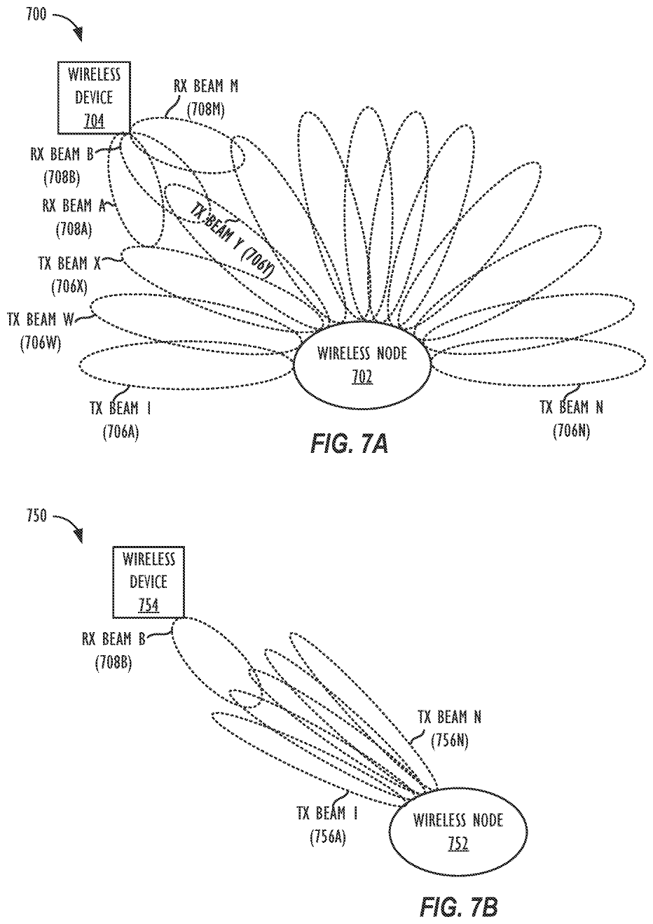

Beamforming may be used to help reduce interference and to help support a larger number of wireless devices. Beamforming effectively allows a transmitter to transmit a dynamic, directional wireless signal toward a wireless device rather than transmitting a cell, or cell sector wide wireless signal. These directional wireless signals may be referred to as beams. As the beams are directed toward a relatively small area as compared to a cell wide signal, a wireless node needs to know where a wireless device is located relative to the wireless node to allow the wireless node to direct beams toward the wireless device. FIGS. 7A and 7B are diagrams illustrating a beam management procedure, in accordance with aspects of the present disclosure. FIG. 7A is a conceptual diagram 700 illustrating an example beam sweeping procedure, in accordance with aspects of the present disclosure. In some wireless systems, a wireless node 702 may be configured with beamforming to transmit wireless signals as relatively narrow beams. To help a wireless device 704 to initially connect to the wireless node 702 when the wireless device 704 enters (e.g., moving into, turned on, exits airplane mode within, etc.) an area served by the wireless node 702, the wireless node 702 may sweep the area served using multiple wide transmit beams 706A . . . 706N (collectively 706). Each beam of the multiple wide transmit beams 706 may be transmitted in predefined directions, with varying azimuths and elevations, and beam of the multiple wide transmit beams 706 may be transmitted periodically in a predefined order in the time domain. For example, the wireless node 702 may first transmit wide transmit beam 1 706A at a certain time, then wide transmit beam W 706 W 20 ms later, then wide transmit beam X 706X another 20 ms later, transmit beam Y 706Y another 20 ms later, and so on through wide transmit beam N 706N, and then repeating. It may be understood that while the current example illustrates a flat, 2D, 180-degree total angle for the multiple beams 706, the actual transmission pattern may encompass any angle and elevation. Additionally, beams of the multiple wide transmit beams 706 may not all have the same shape and may vary in width, height, depth, etc. In some cases, the beams may be referred to as synchronization signal (SS) bursts. The beams may each include a synchronization signal block (SSB) for establishing a connection with the wireless system. The SSBs may be mapped for each beam and an entire cell sector may be covered by the beam sweep. In some cases, the beams of the multiple wide transmit beams 706, while narrower than a sector wide transmission, may be relatively wider beams as compared to the relatively narrower beams that may be used after a wide transmit beam is determined.

In accordance with aspects of the present disclosure, the wireless device 704 performs receive beamforming to conceptually generate corresponding receive beams. A receiving device may beamform by using multiple antennas and applying differing antenna amplification weights to the signals received by the multiple antennas to focus on signals received from a certain direction. The wireless device 704 may generate a set of receive beams and sweep an area for to receive the SS bursts from the wireless node 702. In this example, the wireless device 704 may attempt to receive the SS bursts via receive beams 708A . . . 708M (collectively 708). The wireless device 704 may also periodically sweep (e.g., point a receive beam at) an area around the wireless device 704 to receive the SS bursts. It may be understood that while three receive beams are shown in this example, other implementations may include any number of receive beams. Similarly, receive beams 708 may have varying shapes and sizes.

The wireless device 704 may measure a reference signal received power (RSRP) signal for pairs of wide transmit beams 706 and receive beams 708 to select a pair of a wide transmit beam and a receive beam associated with the best RSRP value. The selected wide transmit beam may be reported to the wireless node 702.

After a pair of the wide transmit beam and the receive beam have been selected, the wide transmit beams may be refined. FIG. 7B is a conceptual diagram 750 illustrating an example transmit beam refinement procedure, in accordance with aspects of the present disclosure. As shown, wireless node 752 may sweep a portion of the area, based on the selected wide transmit beam, using narrow transmit beams, here narrow transmit beams 756A . . . 756N (collectively 756). The narrow transmit beams 756 may have a reduced angular area as compared to the wide transmit beams 706. One or more of the narrow transmit beams 756 may be received by the wireless device 754. The wireless device 754 receives the one or more of the narrow transmit beams 756 using the selected receive beam, here receive beam B 708B and measures a channel state information reference signal (CSI-RS) to estimate the channel for each of the received narrow transmit beams 756. The wireless device 754 may then select a narrow transmit beam of the received narrow transmit beams 756 associated with the best CSI and transmits an indication of the selected narrow transmit beam and CSI report to the wireless node 752. The CSI report includes the CSI information and may be sent to the wireless node to report the CSI information.

Generally, the CSI-RS measurement can provide a better channel quality estimation and channel capacity (e.g., spectral efficiency) estimation as compared to a power measurement provided by RSRP. In some cases, the CSI-RS measurements are used to estimate a downlink channel and may indicate, in addition to RSRP information, channel capacity, frequency/time tracking, rank, demodulation, pre-coding information, etc. In some cases, a beam associated with the best RSRP measurement may not be the same beam with the best CSI-RS measurement. As indicated above, the receive beam 708 may be selected based on RSRP measurements and it may be advantageous to evaluate multiple receive beams based on CSI-RS measurements.

In accordance with aspects of the present disclosure, the wireless device may be configured to evaluate different receive beams without initiating a beam refinement procedure with the wireless node. In cases where a wireless device is experiencing a relatively stable connection, (i.e., relatively stationary, stable environmental conditions, etc.) the wireless device may tune away from the currently selected receive beam to another receive beam to perform a CSI-RS measurement for the other receive beam. If the CSI measurements of the other receive beam indicate that the receive beam is better than the currently selected receive beam, the wireless device may select the other receive beam to use for transmissions from the wireless node.

The wireless device may determine that its connection with the wireless node is relatively stable based on a correlation metric. In some cases, the correlation metric may measure a distance as between two correlation matrices (R₁, R₂), i.e., a correlation distance matrix (CDM), as determined based on measurements of a first and second signal. The CDM for correlation matrices (R₁, R₂) may be defined as

$${d}_{corr} ( {R}_{1} , {R}_{2} ) = 1 - \frac{〈 vec \{ {R}_{1} \} , vec \{ {R}_{2} \} 〉}{{‖ vec \{ {R}_{1} \} ‖}_{2} {‖ vec \{ {R}_{2} \} ‖}_{2}} ,$$

where vec{ } indicates that correlation matrices are vectorized and ∥x∥₂ denotes a Frobenius norm. The determined CDM may be compared to a predefined threshold CDM to determine whether the connection with the wireless node is relatively stable.

After the transmit beam and the receive beam have been selected, the wireless node may configure the wireless device to perform CSI measurements to help manage the beams. In some cases, the wireless node may configure the wireless device for aperiodic CSI reporting. When configured for aperiodic CSI, the wireless device performs CSI reporting when indicated by the wireless node, for example, based on a higher-level DCI message. In some cases, the DCI message may be received via a physical downlink control channel (PDCCH).

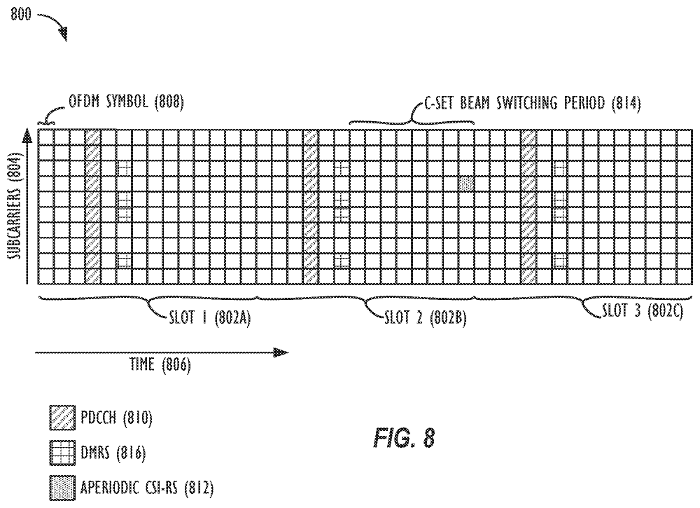

FIG. 8 is a diagram 800 illustrating slot structures of a radio frame, in accordance with aspects of the present disclosure. In this example, slots 802A, 802B, and 802C are shown as a resource gird including a vertical axis 804 corresponding to different frequencies/subcarriers and a horizontal axis 806 corresponding to a time domain. Each column in the resource grid represents an OFDM symbol 808. In this example, a periodic PDCCH transmission 810 may be scheduled in a fourth symbol of each slot and the PDCCH transmission 810 in the slot 2 802B may include a DCI message scheduling an aperiodic CSI report based on a CSI-RS 812 to be transmitted in the last symbol of slot 2 802B.

In some cases, the wireless device may tune away from the selected receive beam to another received beam to measure CSI based on the scheduled CSI-RS 812. As the transmit and receive beams have been selected, the wireless node expects a CSI report based on the CSI-RS 812 for beam management. In some cases, the wireless device may not be able to beamform in a way to enable both the selected receiving beam and the other receiving beam to measure the CSI-RS. In accordance with aspects of the present disclosure, a CSI report for the CSI-RS 812 for the selected beam may be based on a previously sent CSI report in cases where the connection with the wireless node is relatively stable. The wireless device may then tune away to measure the CSI-RS 812 using the other receiving beam during a C-set beam switching period 814. The C-set beams may refer to a set of receive beams which the wireless device may evaluate for use with the wireless node. In some cases, receive beams of the C-set beams may be determined based on the set of receive beams used to sweep the area and/or RSRP values associated with those receive beams.

In some cases, the previously sent CSI report may be modified based on demodulation reference signal (DMRS) 816 estimate. For example, where a DMRS 816 is relatively close in time to the CSI-RS, such as within the same slot, the DMRS 816 may be used to derive rank and a precoding matrix indicator (PMI) for the CSI report.

In some cases, the previously sent CSI report may be modified based on two single port CSI-RS signals transmitted on different symbols. In such cases, the wireless node may switch a precoder on one of the CSI-RS signals on a first symbol to make the precoder orthogonal to a precoder on the other CSI-RS signal on a second symbol. Where the precoder is orthogonal between the symbols, the wireless device is able to estimate the channel for additional antenna ports. Orthogonality of the reference signal may be achieved by using multiple antennal ports, different time and/or frequency resources, etc. In some cases, a space time precoder that renders an independent reference signal per antenna port may be used. The reference signal may be coded using CDMA time/frequency codes to help maintain orthogonality. In some cases, the wireless node may transmit the CSI-RS signal on two antenna ports for tracking using code division multiplexed CSI-RS signals. In some cases, when the wireless device estimates the CSI across multiple antenna ports, the wireless device may be able to switch its precoder to align with the precoded reference signal for the different antenna ports.

In some cases, the wireless device may tune away from the selected narrow transmit beam to another wide transmit beam to measure CSI based on the scheduled CSI-RS 812. In some cases, the narrow transmit beams of the wireless node may be transmitted use a single antenna port. However, for a channel with a rank>1, a CSI measurement on a transmission from multiple orthogonal antenna ports may be needed to determine the rank of the channel. Thus, the wireless device may be configured to measure other wide transmit beams while still using the selected transmit and receive beam pair.

In cases where the wireless node transmits the CSI-RS using a relatively wide beam, the CSI-RS is often not beamformed and may be transmitted using multiple antenna ports. In some cases, the SSB and wide beam sweep may also be transmitted using multiple antenna ports. In such cases, the wireless device may compare a transmission power imbalance of the multiple antenna ports as an indication of channel correlation. For example, the wireless device may rank the wide beams based on an amount of imbalance between the horizontal and vertical polarization receive power to determine a candidate list of possible wide transmit beams for evaluation based on CSI measurements. The wireless node may then tune its receive beams, towards the direction of the other wide transmit beams during the CSI-RS occasion. In some cases, the tune away may be performed when there is no data transmission/reception scheduled for the wireless node and when the wireless node scheduled to transmit a CSI-RS. The wireless device may then determine a CSI report based on the other wide transmit beam for comparison against the CSI report for the current selected transmit beam and determine whether the other wide transmit beam is better.

In cases where the wireless node transmits a beamformed CSI-RS using a narrow transmit beam, the CSI-RS is often specific to a particular wireless node. In some cases, a compound signal may be derived for narrow band channel estimation using orthogonal tracking reference signals (TRS) In such cases, a coarse rank estimate. In other cases, the wireless node may transmit a multi-port aperiodic CSI-RS and the wireless device may use such a CSI-RS for determining a CSI of the other wide transmit beam. In other cases, the wireless device may switch to the other wide transmit beam during slots where the wireless device is not scheduled for and perform the wide transmit beam and receive beam selection process as described above.

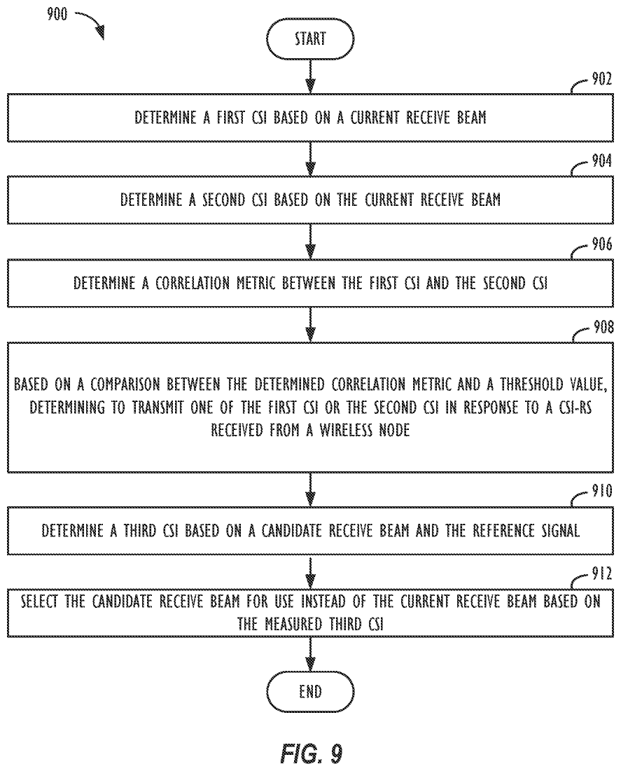

FIG. 9 is a flow diagram 900 illustrating a technique for selecting a receive beam, in accordance with aspects of the present disclosure. At block 902, a first channel state information (CSI) is determined based on a current receive beam. For example, a wireless device may select a wide transmit beam and a receive beam for communicating with a wireless node and the wireless node may configure the wireless device to perform CSI reporting. In some cases, the wireless device may be configured to perform aperiodic CSI reporting. At block 904, a second CSI is determined based on the current receive beam. At block 906, a correlation metric between the first CSI and the second CSI is determined. For example, the wireless device may determine that its connection with the wireless node is relatively stable based on a comparison between correlation distance matrix value and a threshold value. At block 908, the first or second CSI report may be transmitted in response to a CSI reference signal (CSI-RS) transmitted from a wireless node based on a comparison between the determined correlation metric and a threshold value. For example, a previous CSI report may be transmitted for a current CSI instance when the connection with the wireless node is relatively stable. In some cases, the previous CSI report may be modified. For example, the previous CSI report may be modified based on a DMRS from the wireless node. At block 910, a third CSI is determined based on a candidate receive beam and the reference signal. For example, the wireless node may use a candidate receive beam to receive the scheduled CSI-RS and determine a CSI report for the candidate receive beam. At block 912, the candidate receive beam is selected based on the measured third CSI. For example, where the candidate receive beam has a better CSI as compared the CSI of the current receive beam, the candidate receive beam may be selected.

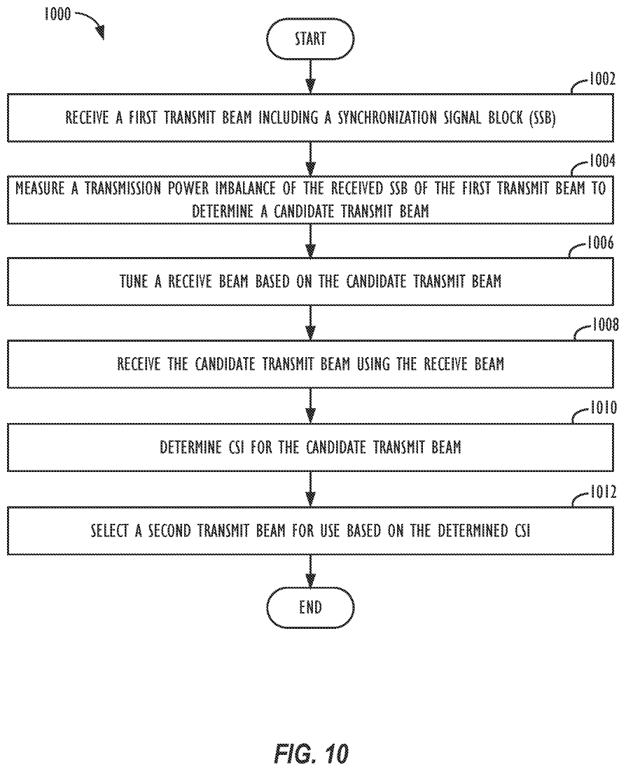

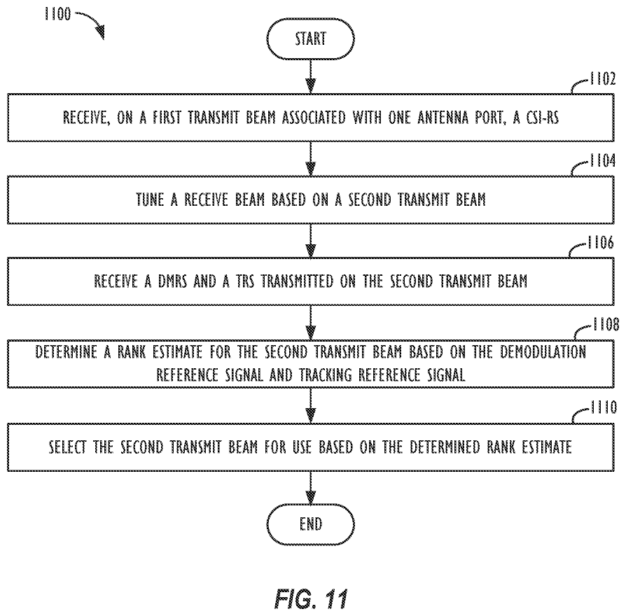

FIG. 10 is a flow diagram 1000 illustrating a technique for selecting a transmit beam, in accordance with aspects of the present disclosure. At block 1002, a wireless device receives a first transmit beam including a synchronization signal block (SSB). For example, a wireless node may be configured to transmit a wide transmit beam sweep and a CSI-RS using multiple antenna ports. At block 1004, a transmission power imbalance of the received SSB of the first transmit beam is measured to determine a candidate transmit beam. For example, the wireless device may rank the wide transmit beams based on an amount of imbalance between the horizontal and vertical receive power to determine a candidate list of possible wide transmit beams for evaluation based on CSI measurements. At block 1006, the wireless device tunes a receive beam based on the candidate transmit beam. For example, the wireless device may tune a receive beam towards a candidate transmit beam. At block 1008, the candidate transmit beam is received using the receive beam. For example, the wireless device may receive a CSI-RS via the candidate transmit beam. At block 1010, channel state information (CSI) is determined for the candidate transmit beam. At block 1012, the second transmit beam is selected for use based on the measured CSI. For example, the CSI associated with the candidate transmit beam may be compared to the CSI of the current transmit beam. Where the CSI of the candidate transmit beam is better than the CSI of the current transmit beam, the candidate transmit beam is selected.

FIG. 11 is a flow diagram 1100 illustrating a technique for selecting a transmit beam, in accordance with aspects of the present disclosure. At block 1102 a wireless device receives, on a first transmit beam transmitted on one antenna port, a channel state information reference signal (CSI-RS). For example, where the CSI-RS is transmitted to the wireless device using a narrow beamformed beam, the CSI-RS may be transmitted using a single antenna port. At block 1104, the wireless device tunes a receive beam based on a second transmit beam. For example, the wireless device may tune a receive beam towards a wide transmit beam of a wireless node. At block 1106, a demodulation reference signal (DMRS) and a tracking reference signal (TRS) transmitted on the second transmit beam are received. For example, the wireless node may receive a DMRS and TRS transmitted by the wireless node using the wide transmit beam. At block 1108 a rank estimate is determined for the second transmit beam based on the DMRS and TRS. For example, where a TRS is transmitted quasi-colocated with a DMRS, a coarse rank may be determined. At block 1110, the second transmit beam is selected for use based on the determined rank estimate.

### EXAMPLES

In the following sections, further exemplary embodiments are provided.

According to Example 1, a method for wireless communications, comprising: determining a first channel state information (CSI) based on a current receive beam; determining a second CSI based on the current receive beam; determining a correlation metric between the first CSI and the second CSI; based on a comparison between the determined correlation metric and a threshold value, determining to transmit one of the first CSI or the second CSI in response to a CSI reference signal (CSI-RS) received from a wireless node; determining a third CSI based on a candidate receive beam and the reference signal; and selecting the candidate receive beam based on the measured third CSI.

Example 2 comprises the subject matter of Example 1, wherein determining the third CSI occurs during a CSI measurement period for the reference signal.

Example 3 comprises the subject matter of Example 1, further comprising modifying the first CSI or the second CSI.

Example 4 comprises the subject matter of Example 3, wherein the first or second CSI is modified based on a demodulation reference signal transmitted by the wireless node.

Example 5 comprises the subject matter of Example 1, wherein the CSI-RS comprises an aperiodic scheduled CSI-RS.

According to Example 6, a method for wireless communications comprising: receiving, by a wireless device, a first transmit beam including a synchronization signal block (SSB); measuring a transmission power imbalance of the received SSB of the first transmit beam to determine a candidate transmit beam; tuning, by the wireless device, a receive beam based on the determined candidate transmit beam; receiving the candidate transmit beam using the receive beam; determining channel state information (CSI) for the candidate transmit beam; and selecting a second transmit beam for receiving based on the measured CSI.

Example 7 comprises the subject matter of Example 6, wherein determining the CSI occurs based on a transmission schedule associated with a receive schedule of the wireless device.

According to Example 8, method for wireless communications comprising: receiving, by a wireless device, on a first transmit beam associated with one antenna port, a channel state information reference signal (CSI-RS); tuning, by the wireless device, a receive beam based on a second transmit beam; receiving, by the wireless device, a demodulation reference signal (DMRS) and a tracking reference signal (TRS) transmitted on the second transmit beam; determining a rank estimate for the second transmit beam based on the DMRS and TRS; and selecting the second transmit beam for use based on the determined rank estimate.

Example 9 comprises the subject matter of Example 8, wherein the DMRS and TRS are quasi-colocated.

According to Example 10, a wireless device comprising: a radio; and a processor operably coupled to the radio, wherein the processor is configured to: determine a first channel state information (CSI) based on a current receive beam; determine a second CSI based on the current receive beam; determine a correlation metric between the first CSI and the second CSI; based on a comparison between the determined correlation metric and a threshold value, determine to transmit one of the first CSI or the second CSI in response to a CSI reference signal (CSI-RS) received from a wireless node; determine a third CSI based on a candidate receive beam and the reference signal; and select the candidate receive beam based on the measured third CSI.

Example 11 comprises the subject matter of Example 10, wherein determining the third CSI occurs during a CSI measurement period for the reference signal.

Example 12 comprises the subject matter of Example 10, wherein the processor is further configured to modify the first CSI or the second CSI.

Example 13 comprises the subject matter of Example 12, wherein the first CSI or the second CSI is modified based on a demodulation reference signal transmitted by the wireless node.

Example 14 comprises the subject matter of Example 10, wherein the CSI-RS comprises an aperiodic scheduled CSI-RS.

According to Example 15, a wireless device comprising a radio; and a processor operably coupled to the radio, wherein the processor is configured to: receive a first transmit beam including a synchronization signal block (SSB); measure a transmission power imbalance of the received SSB of the first transmit beam to determine a candidate transmit beam; tune a receive beam based on the determined candidate transmit beam; receive the candidate transmit beam using the receive beam; determine channel state information (CSI) for the candidate transmit beam; and select a second transmit beam for receiving based on the measured CSI.

Example 16 comprises the subject matter of Example 15, wherein determining the CSI occurs based on a transmission schedule associated with a receive schedule of the wireless device.

According to Example 17, a wireless device comprising: a radio; and a processor operably coupled to the radio, wherein the processor is configured to: receive on a first transmit beam associated with one antenna port, a channel state information reference signal (CSI-RS); tune a receive beam based on a second transmit beam; receive a demodulation reference signal (DMRS) and a tracking reference signal (TRS) transmitted on the second transmit beam; determine a rank estimate for the second transmit beam based on the DMRS and TRS; and select the second transmit beam for use based on the determined rank estimate.

Example 18 comprises the subject matter of Example 17, wherein the DMRS and TRS are quasi-colocated.

According to Example 19, a non-volatile computer-readable medium storing instructions that, when executed, cause a processor to: determine a first channel state information (CSI) based on a current receive beam; determine a second CSI based on the current receive beam; determine a correlation metric between the first CSI and the second CSI; based on a comparison between the determined correlation metric and a threshold value, determine to transmit one of the first CSI or the second CSI in response to a CSI reference signal (CSI-RS) received from a wireless node; determine a third CSI based on a candidate receive beam and the reference signal; and select the candidate receive beam based on the measured third CSI.

Example 20 comprises the subject matter of Example 19, wherein determining the third CSI occurs during a CSI measurement period for the reference signal.

Example 21 comprises the subject matter of Example 19, wherein the computer-readable medium further stores instructions to cause the processor to modify the first CSI or the second CSI.

Example 22 comprises the subject matter of Example 21, wherein the first or second CSI is modified based on a demodulation reference signal transmitted by the wireless node.

Example 23 comprises the subject matter of Example 19, wherein the CSI-RS comprises an aperiodic scheduled CSI-RS.

According to Example 24, a non-volatile computer-readable medium storing instructions that, when executed, cause a processor to: receive a first transmit beam including a synchronization signal block (SSB); measure a transmission power imbalance of the received SSB of the first transmit beam to determine a candidate transmit beam; tune a receive beam based on the determined candidate transmit beam; receive the candidate transmit beam using the receive beam; determine channel state information (CSI) for the candidate transmit beam; and select a second transmit beam for receiving based on the measured CSI.

Example 25 comprises the subject matter of Example 24, wherein determining the CSI occurs based on a transmission schedule associated with a receive schedule of the wireless device.

According to Example 26, a non-volatile computer-readable medium storing instructions that, when executed, cause a processor to: receive on a first transmit beam associated with on one antenna port, a channel state information reference signal (CSI-RS); tune a receive beam based on a second transmit beam; receive a demodulation reference signal (DMRS) and a tracking reference signal (TRS) transmitted on the second transmit beam; determine a rank estimate for the second transmit beam based on the DMRS and TRS; and select the second transmit beam for use based on the determined rank estimate.

Example 27 comprises the subject matter of Example 26, wherein the DMRS and TRS are quasi-colocated.

Yet another exemplary embodiment may include a method, comprising: by a device: performing any or all parts of the preceding Examples.

A yet further exemplary embodiment may include a non-transitory computer-accessible memory medium comprising program instructions which, when executed at a device, cause the device to implement any or all parts of any of the preceding Examples.

A still further exemplary embodiment may include a computer program comprising instructions for performing any or all parts of any of the preceding Examples.

Yet another exemplary embodiment may include an apparatus comprising means for performing any or all of the elements of any of the preceding Examples.

Still another exemplary embodiment may include an apparatus comprising a processor configured to cause a device to perform any or all of the elements of any of the preceding Examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE 106, a BS 102, a network element 600) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for wireless communications, comprising:
determining a first channel state information (CSI) based on a current receive beam;
determining a second CSI based on the current receive beam;
determining a correlation metric between the first CSI and the second CSI;
based on a comparison between the determined correlation metric and a threshold value, determining to transmit one of the first CSI or the second CSI in response to a CSI reference signal (CSI-RS) received from a wireless node;
determining a third CSI based on a candidate receive beam and the reference signal; and
selecting the candidate receive beam based on the measured third CSI.

2. The method of claim 1, wherein determining the third CSI occurs during a CSI measurement period for the reference signal.

3. The method of claim 1, further comprising modifying the first CSI or the second CSI.

4. The method of claim 3, wherein the first CSI or the second CSI is modified based on a demodulation reference signal transmitted by the wireless node.

5. The method of claim 4, wherein the first CSI or the second CSI is modified based on channel estimates from the demodulation reference signal.

6. The method of claim 1, wherein the CSI-RS comprises an aperiodic scheduled CSI-RS.

7. The method of claim 1, further comprising switching to the candidate receive beam to receive the CSI-RS.

8. A wireless device comprising:
a radio; and
a processor operably coupled to the radio, wherein the processor is configured to:
determine a first channel state information (CSI) based on a current receive beam;
determine a second CSI based on the current receive beam;
determine a correlation metric between the first CSI and the second CSI;
based on a comparison between the determined correlation metric and a threshold value, determine to transmit one of the first CSI or the second CSI in response to a CSI reference signal (CSI-RS) received from a wireless node;
determine a third CSI based on a candidate receive beam and the reference signal; and
select the candidate receive beam based on the measured third CSI.

9. The wireless device of claim 8, wherein determining the third CSI occurs during a CSI measurement period for the reference signal.

10. The wireless device of claim 8, wherein the processor is further configured to modify the first CSI or the second CSI.

11. The wireless device of claim 10, wherein the first CSI or the second CSI is modified based on a demodulation reference signal transmitted by the wireless node.

112. The wireless device of claim 11, wherein the first CSI or the second CSI is modified based on channel estimates from the demodulation reference signal.

13. The wireless device of claim 8, wherein the CSI-RS comprises an aperiodic scheduled CSI-RS.

14. The wireless device of claim 8, wherein the processor is further configured to switch to the candidate receive beam to receive the CSI-RS.

15. A non-volatile computer-readable medium storing instructions that, when executed, cause a processor to:
determine a first channel state information (CSI) based on a current receive beam;
determine a second CSI based on the current receive beam;
determine a correlation metric between the first CSI and the second CSI;
based on a comparison between the determined correlation metric and a threshold value, determine to transmit one of the first CSI or the second CSI in response to a CSI reference signal (CSI-RS) received from a wireless node;
determine a third CSI based on a candidate receive beam and the reference signal; and
select the candidate receive beam based on the measured third CSI.

16. The non-volatile computer-readable medium of claim 15, wherein determining the third CSI occurs during a CSI measurement period for the reference signal.

17. The non-volatile computer-readable medium of claim 15, wherein the computer-readable medium further stores instructions to cause the processor to modify the first CSI or the second CSI.

18. The non-volatile computer-readable medium of claim 17, wherein the first or second CSI is modified based on a demodulation reference signal transmitted by the wireless node.

19. The non-volatile computer-readable medium of claim 15, wherein the CSI-RS comprises an aperiodic scheduled CSI-RS.

20. The non-volatile computer-readable medium of claim 15, computer-readable medium further stores instructions to cause the processor to switch to the candidate receive beam to receive the CSI-RS.
